(19) United States
(12) Patent Application Publication
(10) Pub. No.: US 2025/0183680 A1
(43) Pub. Date: Jun. 5, 2025

(54) Battery protection circuit

(71) Applicant: Zgmicro Wuxi Corporation, Wuxi Jiangsu (CN)

(72) Inventor: Hang YIN, Wuxi (CN)

(73) Assignee: Zgmicro Wuxi Corporation, Wuxi (CN)

(21) Appl. No.: 18/530,166

(22) Filed: Dec. 5, 2023

(30) Foreign Application Priority Data
Dec. 5, 2023 (CN) 202211548806.5

(51) Int. Cl. H02J 7/00; H02M 1/00; H02M 1/088; H02M 3/07

(52) U.S. Cl. CPC H02J 7/0029; H02J 7/0048; H02M 1/0095; H02M 1/088; H02M 3/07

(57) ABSTRACT

A battery protection circuit is described. The battery protection circuit comprises: a battery detection circuit configured for generating at least one control signal; at least one power switch; and at least one driving circuit. Each driving circuit comprises a first power terminal coupled to a first voltage, a second power terminal coupled to a second voltage, an output terminal coupled to the control terminal of corresponding one of the at least one power switch and a control terminal receiving corresponding one of the at least one control signal, and outputting a driving signal to the control terminal of the corresponding one of the at least one power switch based on the corresponding one of the at least one control signal so as to turn on or off the corresponding one of the at least one power switch. Each driving circuit selects a higher voltage from the first voltage and the second voltage as a voltage of the driving signal to turn on the corresponding one of the at least one power switch. Therefore, a high potential of the driving signal for the gate of the power switch is improved to be higher than a potential of a positive terminal of the battery, so that an on-resistance of the power switch is reduced, a charging and discharging efficiency of the battery is improved, and heating is reduced.

### CROSS-REFERENCE OF RELATED APPLICATIONS

The present invention claims priority of Chinese Patent Application No. 202211548806.5 filed in China on Dec. 5, 2022, the entire contents of which are incorporated herein by reference.

### BACKGROUND OF THE INVENTION

### Field of the Invention

The invention relates to the field of circuit design, in particular to a battery protection circuit providing a high driving voltage for a gate of each power transistor.

### Description of the Related Art

FIG. 1 shows a schematic circuit diagram of a first example of a conventional battery protection circuit. Two NMOS (i.e., N-Metal-Oxide-Semiconductor) power switches MND, MNC are coupled in series on a charging and discharging loop of a battery. The battery comprises one battery cell or a plurality of battery cells. When a voltage of a drive signal DOUT of the NMOS power switch MND controlled by the battery protection circuit rises and is higher than a threshold voltage, the NMOS power switch MND is turned on to allow a load system to be discharged through a first power port P+ and a second power port P−. When a voltage of a drive signal COUT of the NMOS power switch MNC controlled by the battery protection circuit rises and is higher than the threshold voltage, the NMOS power switch MNC is turned on to allow the battery to be charged by a charger through the first power port P+ and the second power port P−.

A specific control mode of the drive signals DOUT and COUT is shown in FIG. 1. When a battery detection circuit 110 determines that discharging is allowed, an output signal dischg_ctrl of a logic module is logic low, a NMOS transistor MN1 is turned off, a PMOS transistor MP1 is turned on, and a potential of the drive signal DOUT is pulled up to the potential of P+. When the battery detection circuit 110 determines that the discharging is prohibited, the output signal dischg_ctrl of the logic module is logic high and higher than a cut-off voltage of the PMOS transistor MP1, the NMOS transistor MN1 is turned on, the PMOS transistor MP1 is turned off, and the potential of the drive signal DOUT is pulled down to a ground potential. When the battery detection circuit 110 determines that charging is allowed, the output signal chg_ctrl of the logic module is logic low, the NMOS transistor MN2 is turned off, the PMOS transistor MP2 is turned on, the potential of the drive signal COUT is pulled up to the potential of P+. When the battery detection circuit 110 determines that the charging is prohibited, the output signal chg_ctrl of the logic module is logic high, the NMOS transistor MN2 is turned on, the PMOS transistor MP2 is turned off, and the potential of the drive signal COUT is pulled down to the potential of P−.

The battery comprises one battery cell or a plurality of battery cells in series and parallel. In addition, there is also an existing method in which a drain coupled between the NMOS power switch MND and the MNC is used as the second power port P− to supply power to the load system, and a source of the NMOS power switch MNC is used as a port coupled to a negative terminal of the charger for charging.

FIG. 2 is a schematic circuit diagram of a second example of the conventional battery protection circuit. The circuit shown in FIG. 2 is similar to that shown in FIG. 1, and a main difference between FIG. 2 and FIG. 1 is that sources of the PMOS transistors MP1 and MP2 in FIG. 2 are not directly powered by P+, but are coupled to an output voltage LDO_OUT of a linear voltage regulator LDO. Thus, the potential of the drive signals DOUT and COUT are pulled up to a voltage lower than P+.

Regardless of FIG. 1 or FIG. 2, the highest potential that the driving signals DOUT and COUT can reach would not be higher than P+. That is, the highest potential that the driving signals DOUT and COUT can reach will not be higher than the voltage of the positive terminal of the battery. On-resistances of the NMOS power switches MND and MNC are affected by the voltage of the gates of the NMOS power switches MND and MNC. A specific relationship is that in the on-state, the lower the voltage of the gate is, the larger the on-resistance is. Therefore, when the voltage of the battery becomes lower after discharging, the voltages of the driving signals DOUT and COUT are reduced following P+, the on-resistances of the NMOS power switches MND and MNC are gradually increased, the charging and discharging efficiency of the battery is deteriorated, and the heating of the NMOS power switches MND and MNC is increased. Moreover, the voltages of the gates of the NMOS power switches MND and MNC are not higher than P+, and the potential of the power switches to achieve smaller on-resistance with higher gate voltage cannot be fully utilized.

FIG. 3 is a schematic circuit diagram of a third example of the conventional battery protection circuit. A single NMOS (N-Metal-Oxide-Semiconductor) power switch MNDC is coupled in series on the charging and discharging loop of the battery. When the voltage of the drive signal SW_GATE of the NMOS power switch MNDC controlled by the battery protection circuit rises and is higher than the threshold voltage, the NMOS power switch MNDC is turned on to allow the charging and the discharging through the first power port P+ and the second power port P−.

In order to ensure that the potential of SW_GATE can be low enough to turn off the NMOS power switch MNDC and avoid the situation that when the voltage of the gate of the NMOS power switch MNDC is lower than the threshold voltage, a parasitic diode from the bulk to the source or the drain of the NMOS power switch MNDC generates forward bias conduction leakage, a voltage selection module lower_sel selects the lower potential from the ground potential and the P− potential as the output thereof. A first input terminal of the voltage selection module is coupled to the source of the NMOS power switch MNDC, a second input terminal of the voltage selection module is coupled to the drain of the NMOS power switch MNDC, an output terminal of the voltage selection module is coupled to the bulk of the NMOS power switch MNDC. The source of the NMOS transistor MN1 is coupled to the bulk of the NMOS power switch MNDC.

As shown in FIG. 3, when the battery detection circuit 110 determines that the charging or the discharging is allowed, an output signal ctrl of the logic module is logic low, the transistor MN1 is turned off, the transistor MP1 is turned on, and the driving signal SW_GATE is pulled up to P+. When the battery detection circuit 110 determines that the charging is prohibited or the discharging is prohibited, the output signal ctrl of the logic module is logic high and is higher than the cut-off voltage of the PMOS transistor MP1, the NMOS transistor MN1 is turned on, the PMOS transistor MP1 is turned off, and the driving signal SW_GATE is pulled down to the potential lower_volt. The battery comprises one battery cell or a combination of multiple battery cells in series and parallel.

FIG. 4 is a schematic circuit diagram of a fourth example of the conventional battery protection circuit. The circuits shown in FIG. 4 and FIG. 3 are similar, and the main difference between FIG. 4 and FIG. 3 is that the source of the PMOS transistor MP1 in FIG. 4 is not directly powered by P+, but is coupled to an output voltage LDO_OUT of a linear voltage regulator LDO. Thus, the high potential of the drive signal SW_GATE is a voltage lower than P+. Regardless of FIG. 3 or FIG. 4, the highest potential that the drive signal SW_GATE can reach is not higher than P+, that is, not higher than the voltage of the positive terminal of the battery. The on-resistance of the NMOS power switch MNDC is affected by the voltage of the gate. The specific relationship is that in the on-state, the lower the gate voltage is, the larger the on-resistance is. Therefore, when the voltage of the battery decreases after discharging, the voltage of the driving signal SW_GATE decreases following P+, the on-resistance of the NMOS power switch MNDC increases gradually, the charging and discharging efficiency of the battery decreases, and the heating of the NMOS power switch MNDC increases. The voltage of the gate of the NMOS power switch MNDC does not exceed P+ at most, and the potential of the power switch to achieve smaller on-resistance with higher gate voltage cannot be fully utilized. Therefore, there is a need for an improved technical solution to overcome the above problems.

### SUMMARY OF THE INVENTION

One of the objects of the present invention is to provide a battery protection circuit capable of providing a higher drive voltage for a gate of each power transistor, which can reduce on-resistance of each power transistor, improve charging and discharging efficiency of the battery, and reduce heating.

According to an aspect of the present invention, the present invention provides a battery protection circuit. The battery protection circuit comprises: a battery detection circuit configured for detecting a charging and discharging state of a battery and generating at least one control signal; at least one power switch, each power switch comprising a control terminal and coupled in series in a charging and discharging loop of the battery; and at least one driving circuit, each driving circuit corresponding to one of the at least one power switch and one of the at least one control signal, comprising a first power terminal coupled to a first voltage, a second power terminal coupled to a second voltage, an output terminal coupled to the control terminal of corresponding one of the at least one power switch and a control terminal receiving corresponding one of the at least one control signal, and outputting a driving signal to the control terminal of the corresponding one of the at least one power switch based on the corresponding one of the at least one control signal received by the control terminal thereof so as to turn on or off the corresponding one of the at least one power switch, wherein each driving circuit selects a higher voltage from the first voltage and the second voltage as a voltage of the driving signal to turn on the corresponding one of the at least one power switch

The battery protection circuit provided in the present invention adopts a charge pump which can increase a high potential of the drive signal of the power transistor (also be referred to as the power switch) to the potential higher than the potential of the positive terminal of the battery, so as to achieve the purpose of lowering the on-resistance of the power transistor, increasing the charging and discharging efficiency of the battery, and reducing the heating.

### BRIEF DESCRIPTION OF THE DRAWINGS

These and other features, aspects, and advantages of the present invention will become better understood with regard to the following description, appended claims, and accompanying drawings wherein:

FIG. 1 shows a schematic circuit diagram of a first example of a conventional battery protection circuit;

FIG. 2 shows a schematic circuit diagram of a second example of the conventional battery protection circuit;

FIG. 3 shows a schematic circuit diagram of a third example of the conventional battery protection circuit;

FIG. 4 shows a schematic circuit diagram of a fourth example of the conventional battery protection circuit;

FIG. 5 shows a schematic circuit diagram of a battery protection circuit according to a first embodiment of the present invention;

FIG. 6 shows a schematic circuit diagram of the battery protection circuit according to a second embodiment of the present invention;

FIG. 7 shows a schematic circuit diagram of the battery protection circuit according to a third embodiment of the present invention;

FIG. 8 shows a schematic circuit diagram of the battery protection circuit according to a fourth embodiment of the present invention;

FIG. 9 shows a schematic circuit diagram of the battery protection circuit according to a fifth embodiment of the present invention;

FIG. 10 shows a schematic circuit diagram of the battery protection circuit according to a sixth embodiment of the present invention;

FIG. 11 shows a schematic circuit diagram of the battery protection circuit according to a seventh embodiment of the present invention; and

FIG. 12 shows a schematic circuit diagram of the battery protection circuit according to an eighth embodiment of the present invention.

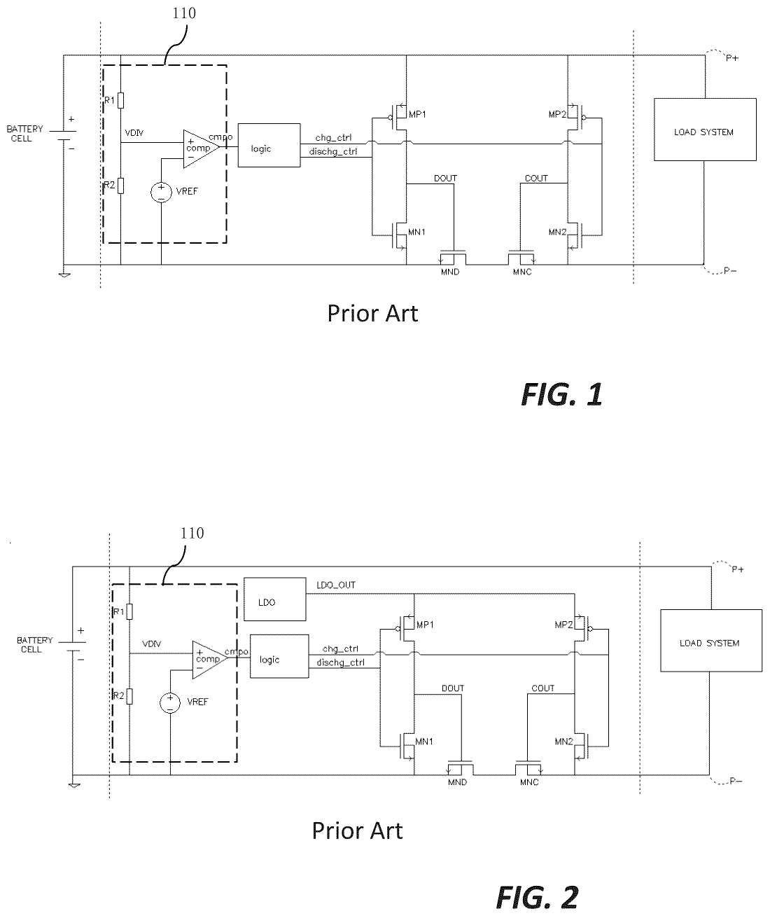

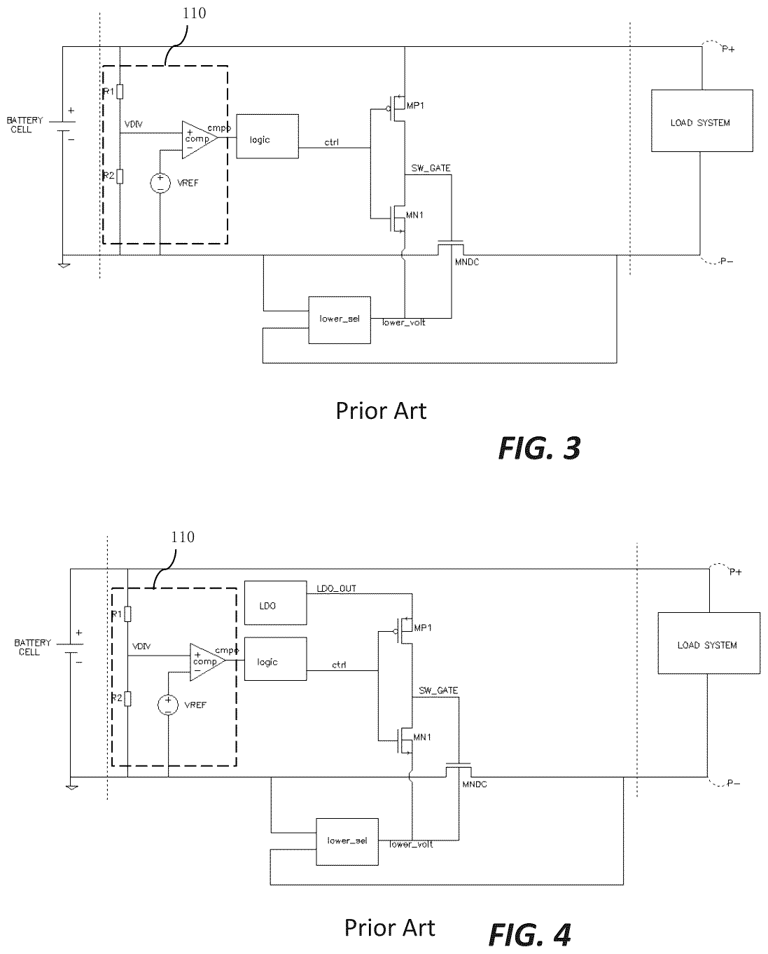

### DETAILED DESCRIPTION OF THE PREFERRED EMBODIMENTS

The detailed description of the invention is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

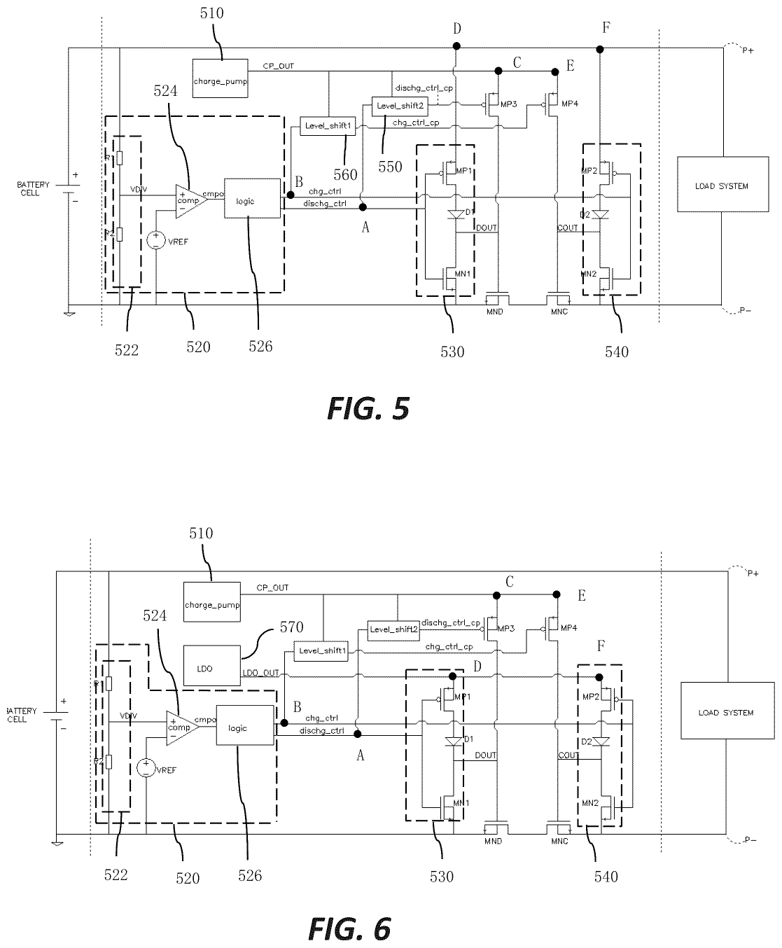

FIG. 5 is a schematic diagram of a battery protection circuit capable of providing a higher drive voltage for a gate of each power transistor according to a first embodiment of the present invention. The battery protection circuit shown in FIG. 5 comprises a charge pump 510, a battery detection circuit 520, a first driving circuit (not labeled), a second driving circuit (not labeled), a discharging power switch MND which may also be referred to as a discharging power transistor, and a charging power switch MNC which may also be referred to as a charging power transistor.

The battery detection circuit 520 is configured to detect a charging or discharging state of the battery and generate a charging control signal chg_ctrl and a discharging control signal dischg_ctrl. In the embodiment shown in FIG. 5, the battery detection circuit 520 comprises a voltage divider 522, a reference voltage VREF, a comparator 524, and a logic module 526. The voltage divider 522 comprises a first voltage dividing resistor R1 and a second voltage dividing resistor R2 which are sequentially coupled in series between a positive terminal and a negative terminal of the battery, and a connection node between the first voltage dividing resistor R1 and the second voltage dividing resistor R2 provides a feedback voltage VDIV. The comparator 524 has a first input terminal coupled to the feedback voltage VDIV and a second input terminal coupled to the reference voltage VREF. The comparator 524 is configured to compare the feedback voltage VDIV with the reference voltage VREF and output a comparison result through an output terminal thereof. The logic module 526 generates the charging control signal chg_ctrl and the discharging control signal dischg_ctrl according to the comparison result output by the comparator 524. In the embodiment shown in FIG. 5, the first input terminal and the second input terminal of the comparator 524 are a non-inverting input terminal and an inverting input terminal of the comparator 524, respectively.

The discharging power switch MND and the charging power switch MNC are coupled in series in the charging and discharging loop of the battery. In the embodiment shown in FIG. 5, the discharging power switch MND and the charging power switch MNC are sequentially coupled in series between the negative terminal of the battery and the second power port P−. A source of the discharging power switch MND is coupled to the negative terminal of the battery, and a drain of the discharging switch MND is coupled to a drain of the charging power switch MNC. A source and a bulk of the charging power switch MNC are coupled with the second power port P−, the source and a bulk of the discharging power switch MND are coupled with the negative terminal of the battery. In the embodiment shown in FIG. 5, both the discharging power switch MND and the charging power switch MNC are NMOS transistors.

The first driving circuit has a first power terminal C coupled to a first voltage and a second power terminal D coupled to a first power port P+. In the embodiment shown in FIG. 5, the charge pump 510 provides the first voltage CP_OUT. The first power port P+ is coupled to the positive terminal of the battery, the voltage of the first power port P+ may be referred to as a second voltage. The first power port P+ and the second power port P− may be coupled to a load system. The first driving circuit has an output terminal DOUT coupled to the control terminal of the discharge power switch MND, and a control terminal coupled to the discharge control signal dischg_ctrl output by the battery detection circuit 520. The first driving circuit outputs a corresponding first driving signal DOUT to the control terminal of the discharge power switch MND according to the discharge control signal dischg_ctrl, so as to drive the discharge power switch MND to be turned on or off.

In the embodiment shown in FIG. 5, the first driving circuit comprises a first primary driving unit 530 and a first secondary driving unit.

The first primary driving unit 530 comprises a PMOS transistor MP1, an NMOS transistor MN1, and a first unidirectional conduction element. A first diode D1 is used as the first unidirectional conduction element in the embodiment shown in FIG. 5. The PMOS transistor MP1 and the first unidirectional conduction element is coupled in series between the second power terminal D of the first driving circuit and the output terminal DOUT of the first driving circuit. The first unidirectional conduction element is conductive in a direction from the second power terminal D of the first driving circuit to the output terminal DOUT of the first driving circuit, and is not conductive in a direction from the output terminal DOUT of the first driving circuit to the second power terminal D of the first driving circuit. In the specific embodiment shown in FIG. 5, the PMOS transistor MP1 and the first unidirectional conduction element are sequentially coupled in series between the second power terminal D of the first driving circuit and the output terminal DOUT of the first driving circuit. Specifically, the PMOS transistor MP1 has a source coupled to the second power terminal D of the first driving circuit, and a drain coupled to one terminal (for example, a positive terminal of the first diode D1) of the first unidirectional conduction element. The other terminal of the first unidirectional conduction element (for example, a negative terminal of the first diode D1) is coupled to the output terminal DOUT of the first driving circuit. The NMOS transistor MN1 is coupled between the output terminal DOUT of the first driving circuit and the bulk of the discharging power switch MND. The bulk of the discharging power switch MND is coupled to the source of the discharging power switch MND. The gate of the PMOS transistor MP1 and the gate of the NMOS transistor MN1 are coupled to the control terminal A of the first driving circuit. When the discharge control signal dischg_ctrl is at a first logic level, it indicates that the discharge loop of the battery is abnormal, and the PMOS transistor MP1 is controlled to be turned off and the NMOS transistor MN1 is controlled to be turned on, so that the discharging power switch MND is turned off. When the discharge control signal dischg_ctrl is at a second logic level, it indicates that the discharge loop of the battery is normal, the PMOS transistor MP1 is controlled to be turned on and the NMOS transistor MN1 is controlled to be turned off, so that the discharging power switch MND is turned on.

The first secondary driving unit has a first connecting terminal coupled to a first power terminal C of the first driving circuit, a second connecting terminal coupled to the output terminal DOUT of the first driving circuit, and a control terminal coupled to a control terminal A of the first driving circuit. When the discharge control signal dischg_ctrl is at the first logic level, it indicates that the discharge loop of the battery is abnormal, the first secondary driving unit is controlled to discouple the first power terminal C of the first driving circuit and the output terminal DOUT of the first driving circuit. When the discharge control signal dischg_ctrl is at the second logic level, it indicates that the discharge loop of the battery is normal, the first secondary driving unit is controlled to couple the first power terminal C of the first driving circuit to the output terminal DOUT of the first driving circuit.

In the specific embodiment shown in FIG. 5, the first secondary driving unit comprises a first level shift module 550 and a PMOS transistor MP3. The PMOS transistor MP3 has a source coupled with the first power terminal C of the first driving circuit, and a drain coupled with the output terminal DOUT of the first driving circuit. The first level shift module 550 has an input terminal coupled to the control terminal A of the first driving circuit, and an output terminal coupled to a gate of the PMOS transistor MP3. The first level shift module 550 is configured to perform level shift on the discharge control signal dischg_ctrl to generate a level shift signal dischg_ctr_CP, and output the level shift signal dischg_ctr_CP to the gate of the PMOS transistor MP3 through the output terminal thereof. A high level (namely high potential) of the level shift signal dischg_ctr_CP is equal to the first voltage CP_OUT provided by the charge pump 510. When the discharge control signal dischg_ctrl is at the first logic level, the PMOS transistor MP3 is controlled to be turned off by the first level shift module 550, so that the first power terminal C of the first driving circuit is discoupled with the output terminal DOUT of the first driving circuit. When the discharge control signal dischg_ctrl is at the second logic level, the PMOS transistor MP3 is controlled to be turned on by the first level shift module 550, so that the first power terminal C of the first driving circuit is coupled with the output terminal DOUT of the first driving circuit through the first secondary driving unit.

In order to facilitate the understanding of the present invention, an operation of the battery protection circuit driving the discharging power switch MND shown in FIG. 5 will be described in detail below.

When the discharge control signal dischg_ctrl is at the high level which may be referred to as the first logic level, it indicates that the discharge loop of the battery is abnormal. The level shift signal dischg_ctr_CP output by the first level shift module 550 is the high level which is equal to the first voltage CP_OUT. The PMOS transistor MP3 is controlled to be turned off. The discharge control signal dischg_ctrl enable that the PMOS transistor MP1 is turned off, and the NMOS transistor MN1 is turned on. As a result, the output terminal DOUT of the first driving circuit is pulled down to a ground level (e.g. low level) by the NMOS transistor MN1, so that the discharging power switch MND is driven to be turned off, and the discharge loop of the battery is cut off.

When the discharge control signal dischg_ctrl is at the low level which may be referred to as the second logic level, it indicates that the discharge loop of the battery is normal. At this time, the level shift signal dischg_ctr_CP output by the first level shift module 550 is at the low level. The PMOS transistor MP3 and the PMOS transistor MP1 are controlled to be turned on, the NMOS transistor MN1 is controlled to be turned off. The output terminal DOUT of the first driving circuit is pulled up to larger one of the first voltage CP_OUT and the second voltage by the PMOS transistor MP3 and the PMOS transistor MP1, so that the discharging power switch MND is driven to be turned on, and the discharge loop of the battery is turned on.

The first unidirectional conduction element allows the PMOS transistor MP1 to pull up the voltage of the output terminal DOUT of the first driving circuit when the voltage of the source of the PMOS transistor MP1 is higher than the voltage of the output terminal DOUT of the first driving circuit. However, when the output terminal DOUT of the first driving circuit is pulled up to a voltage higher than the voltage of the source of the PMOS transistor MP1 by the PMOS transistor MP3, the first unidirectional conduction element prevents the output terminal DOUT of the first driving circuit from flowing current back to the second power terminal D through the PMOS transistor MP1.

In the embodiment shown in FIG. 5, the first voltage CP_OUT provided by the charge pump 510 is higher than the voltage of the first power port P+ which may be referred to as the second voltage. The voltage of the first power port P+ is equal to the voltage of the positive terminal of the battery. When the PMOS transistor MP3 is turned on, the output terminal DOUT of the first driving circuit can be pulled up to the first voltage CP_OUT higher than the voltage of the positive terminal of the battery to drive the discharging power switch MND to be turned on, thereby reducing a limitation of the voltage of the battery to the high potential of the discharge driving signal DOUT.

The second driving circuit has a first power terminal E coupled to the first voltage. In the embodiment shown in FIG. 5, the charge pump 510 provides the first voltage CP_OUT. A second power terminal F of the second driving circuit is coupled to the first power port P+. The first power port P+ is coupled to the positive terminal of the battery. The voltage of the first power port P+ may be referred to as the second voltage, and the first power port P+ and the second power port P− may be coupled to the load system. The output terminal COUT of the second driving circuit is coupled to the control terminal of the charging power switch MNC, and the control terminal B of the second driving circuit receives the charging control signal chg_ctrl output by the battery detection circuit 520. The second driving circuit outputs a second driving signal COUT to the control terminal of the charging power switch MNC through the output terminal thereof according to the charging control signal chg_ctrl, so as to drive the charging power switch MNC to be turned on or off.

In the embodiment shown in FIG. 5, the second driving circuit comprises a second primary driving unit 540 and a second secondary driving unit.

The second primary driving unit 540 comprises a PMOS transistor MP2, an NMOS transistor MN2, and a second unidirectional conduction element. A second diode D2 is used as the second unidirectional conduction element in the embodiment shown in FIG. 5. The PMOS transistor MP2 and the second unidirectional conduction element is coupled in series between the second power terminal F of the second driving circuit and the output terminal COUT of the second driving circuit. The second unidirectional conduction element is conductive in a direction from the second power terminal F of the second driving circuit to the output terminal COUT of the second driving circuit, and the second unidirectional conduction element is not conductive in a direction from the output terminal COUT to the second power terminal F. In the specific embodiment shown in FIG. 5, the PMOS transistor MP2 and the second unidirectional conduction element are sequentially coupled in series between the second power terminal F of the second driving circuit and the output terminal COUT of the second driving circuit. The PMOS transistor MP2 has a source coupled to the second power terminal F of the second driving circuit, a drain coupled to one terminal (for example, a positive terminal of the second diode D2) of the second unidirectional conduction element. The other terminal (for example, a negative terminal of the second diode D2) of the second unidirectional conduction element is coupled to the output terminal COUT of the second driving circuit. The NMOS transistor MN2 is coupled between the output terminal COUT of the second driving circuit and the bulk of the charging power switch MNC. The bulk of the charging power switch MNC is coupled to the source of the charging power switch MNC. The gate of the PMOS transistor MP2 and the gate of the NMOS transistor MN2 are coupled to a control terminal B of the second driving circuit. When the charging control signal chg_ctrl is at the first logic level, it indicates that the charging loop of the battery is abnormal, the PMOS transistor MP2 is controlled to be turned off and the NMOS transistor MN2 is controlled to be turned on. When the charging control signal chg_ctrl is at the second logic level, it indicates that the charging loop of the battery is normal, the PMOS transistor MP2 is controlled to be turned on and the NMOS transistor MN2 is controlled to be turned off.

The second secondary driving unit has a first connecting terminal coupled to the first power terminal E of the second driving circuit, a second connecting terminal coupled to the output terminal COUT of the second driving circuit, and a control terminal coupled to the control terminal B of the second driving circuit. When the charging control signal chg_ctrl is at the first logic level, it indicates that the charging loop of the battery is abnormal, the second secondary driving unit is controlled to cut off the connection between the first power terminal E of the second driving circuit and the output terminal COUT of the second driving circuit. When the charging control signal chg_ctrl is at the second logic level, it indicates that the charging loop of the battery is normal, the second secondary driving unit is controlled to couple the first power terminal E of the second driving circuit to the output terminal COUT of the second driving circuit.

In the specific embodiment shown in FIG. 5, the second secondary driving unit comprises a second level shift module 560 and a PMOS transistor MP4. The PMOS transistor MP4 has a source coupled with the first power terminal E of the second driving circuit, and a drain coupled with the output terminal COUT of the second driving circuit. The second level shift module 560 has an input terminal coupled to the control terminal B of the second driving circuit, and an output terminal coupled to the gate of the PMOS transistor MP4. The second level shift module 560 is configured to perform level shift on the received charging control signal chg_ctrl to generate a level shift signal chg_ctrl_CP, and output the level shift signal chg_ctrl_CP to the gate of the PMOS transistor MP4 through the output terminal thereof. The high level of the level shift signal chg_ctrl_CP is equal to the first voltage CP_OUT provided by the charge pump 510. When the charging control signal chg_ctrl is at the first logic level, the second level shifting module 560 controls the PMOS transistor MP4 to be turned off, so as to cut off the connection between the first power terminal E of the second driving circuit and the output terminal COUT of the second driving circuit. When the charging control signal chg_ctrl is at the second logic level, the second level shift module 560 controls the PMOS transistor MP4 to be turned on, so that the first power terminal E of the second driving circuit is coupled to the output terminal COUT of the second driving circuit.

In order to facilitate the understanding of the present invention, an operation of the battery protection circuit driving the charging power switch MNC shown in FIG. 5 to will be described in detail below.

When the charging control signal chg_ctrl is at the high level which may be referred to as the first logic level, it indicates that the charging loop of the battery is abnormal. The level shift signal chg_ctrl_CP output by the second level shift module 560 is the high level which is equal to the first voltage CP_OUT, the PMOS transistor MP4 is controlled to be turned off, the charging control signal chg_ctrl controls the PMOS transistor MP2 to be turned off, and the NMOS transistor MN2 to be turned on, the output terminal COUT of the second driving circuit is pulled down to the second power port P− by the NMOS transistor MN2, so that the charging power switch MNC is turned off and the charging loop of the battery is turned off.

When the charging control signal chg_ctrl is at the low level which may be referred to as the second logic level, it indicates that the charging loop of the battery is normal. At this time, the level shift signal chg_ctrl_CP output by the second level shift module 560 is at the low level, the PMOS transistor MP4 is controlled to be turned on. The charge control signal chg_ctrl controls the PMOS transistor MP2 to be turned on and the NMOS transistor MN2 to be turned off. The output terminal COUT of the second driving circuit is pulled up to the larger one of the first voltage CP_OUT provided by the charge pump 510 and the second voltage, so that the charging power switch MNC is is turned on and the charging loop of the battery is turned on.

The second unidirectional conduction element allows the PMOS transistor MP2 to pull up the voltage of the output terminal COUT of the second driving circuit when the voltage of the source of the PMOS transistor MP2 is higher than the voltage of the output terminal COUT of the second driving circuit. However, when the output terminal COUT of the second driving circuit is pulled up to a voltage higher than the voltage of the source of the PMOS transistor MP2 by the PMOS transistor MP4, the second unidirectional conduction element prevents the output terminal DOUT of the second driving circuit from flowing current back to the second power terminal F through the PMOS transistor MP2.

In the embodiment shown in FIG. 5, the first voltage CP_OUT provided by the charge pump 510 is higher than the voltage of the first power port P+ which may be referred to as the second voltage. The voltage of the first power port P+ is equal to the positive voltage of the battery. Thus, when the PMOS transistor MP4 is turned on, the output terminal COUT of the second driving circuit can be pulled up to the first voltage CP_OUT higher than the positive voltage of the battery to drive the charging power switch MNC to be turned on, thereby reducing the limitation of the voltage of the battery to the high potential of the charge driving signal COUT.

FIG. 6 is a schematic circuit diagram of the battery protection circuit according to a second embodiment of the present invention. The battery protection circuits shown in FIG. 6 and FIG. 5 are basically the same, and the main difference between the battery protection circuits shown in FIG. 6 and FIG. 5 is that the sources of the PMOS transistor MP1 and the PMOS transistor MP2 are not coupled to the first power port P+ in FIG. 6, but are coupled to an output voltage LDO_OUT of the linear voltage regulator (LDO) 570. It can also be said that the second power terminal D of the first driving circuit and the second power terminal F of the second driving circuit are not coupled to the first power port P+ in FIG. 6, but are coupled to the output voltage LDO_OUT which can be referred to as the second voltage. The first voltage CP_OUT provided by the charge pump 510 is higher than the output voltage LDO_OUT of the linear voltage regulator 570. The working processes of the battery protection circuits shown in FIG. 6 and FIG. 5 are basically the same and will not be repeated here.

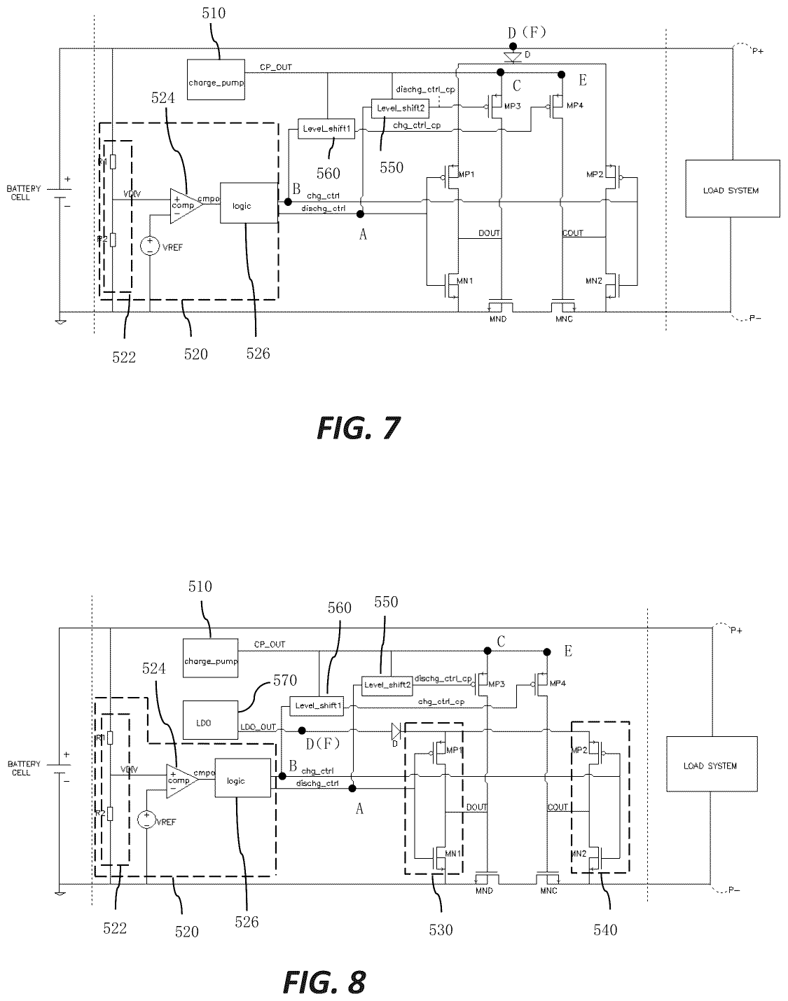

FIG. 7 is a schematic diagram of the battery protection circuit according to a third embodiment of the present invention. The battery protection circuits shown in FIG. 7 and FIG. 5 are basically the same, and the main differences between the battery protection circuits shown in FIG. 7 and FIG. 5 are as follows: in FIG. 7, the first diode D1 and the PMOS transistor MP1 are sequentially coupled in series between the second power terminal D of the first driving circuit and the output terminal DOUT of the first driving circuit, the second diode D2 and the PMOS transistor MP2 are sequentially coupled in series between the second power terminal F of the second driving circuit and the output terminal COUT of the second driving circuit, and the first driving circuit and the second driving circuit share the same unidirectional conduction element (e.g., the diode D), so that one unidirectional conduction element can be saved. In other words, the first diode D1 and the second diode D2 are the same diode. Specifically, one terminal of the unidirectional conduction element is coupled to the second power terminal D of the first driving circuit and the second power terminal F of the second driving circuit, and the other terminal of the unidirectional conduction element is coupled to the sources of the PMOS transistor MP1 and the PMOS transistor MP2. The drain of the PMOS transistor MP1 is coupled to the output terminal DOUT of the first driving circuit, and the drain of the PMOS transistor MP2 is coupled to the output terminal COUT of the second driving circuit.

FIG. 8 is a schematic diagram of the battery protection circuit according to a fourth embodiment of the present invention. The main difference between the battery protection circuits shown in FIG. 8 and FIG. 6 is that in FIG. 8, the first diode D1 and the PMOS transistor MP1 are sequentially coupled in series between the second power terminal D of the first driving circuit and the output terminal DOUT of the first driving circuit, the second diode D2 and the PMOS transistor MP2 are sequentially coupled in series between the second power terminal F of the second driving circuit and the output terminal COUT of the second driving circuit, and the first driving circuit and the second driving circuit share the same diode D, so that one unidirectional conduction element can be saved. Specifically, the positive terminal of the diode D is coupled to the second power terminal D of the first driving circuit and the second power terminal F of the second driving circuit, and the negative terminal of the diode D is coupled to the sources of the PMOS transistor MP1 and the PMOS transistor MP2. The drain of the PMOS transistor MP1 is coupled to the output terminal DOUT of the first driving circuit, and the drain of the PMOS transistor MP2 is coupled to the output terminal COUT of the second driving circuit. The battery comprises one batter cell or a plurality of batter cell coupled in series and parallel.

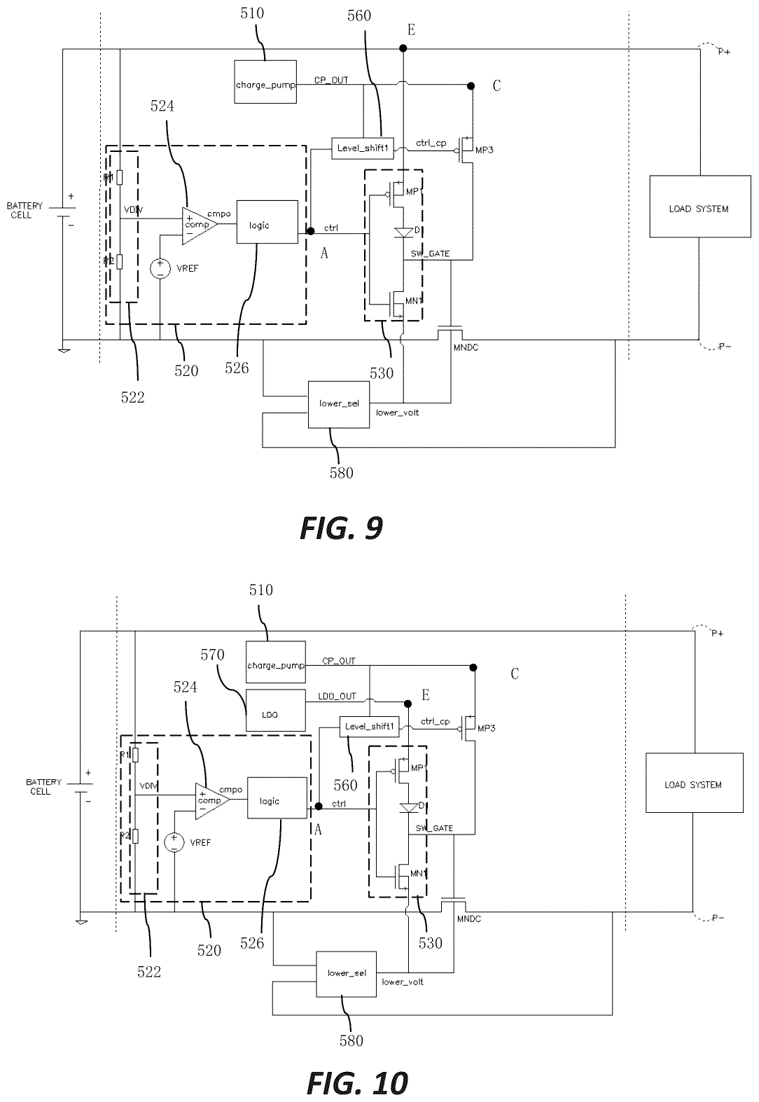

FIG. 9 is a schematic diagram of the battery protection circuit according to a fifth embodiment of the present invention. The battery protection circuit shown in FIG. 9 comprises a charge pump 510, a battery detection circuit 520, a driving circuit, a charging and discharging power switch MNDC, and a lower voltage selection circuit 580.

The battery detection circuit 520 is configured to detect a charging or discharging state of the battery and generate a control signal. In the embodiment shown in FIG. 9, the battery detection circuit 520 comprises a voltage divider 522, a reference voltage VREF, a comparator 524, and a logic module 526. The voltage divider 522 comprises a first voltage dividing resistor R1 and a second voltage dividing resistor R2 which are sequentially coupled in series between the positive terminal and the negative terminal of the battery, and a connection node between the first voltage dividing resistor R1 and the second voltage dividing resistor R2 provides a feedback voltage VDIV. The comparator 524 has a first input terminal coupled to the feedback voltage VDIV and a second input terminal coupled to the reference voltage VREF. The comparator 524 is configured to compare the feedback voltage VDIV with the reference voltage VREF and output a comparison result through an output terminal thereof. The logic module 526 generates a corresponding control signal according to the comparison result. In the embodiment shown in FIG. 9, the first input terminal and the second input terminal of the comparator 524 are a non-inverting input terminal and an inverting input terminal of the comparator 524, respectively.

The charging and discharging power switch MNDC is coupled in series in the charging and discharging loop of the battery. In the embodiment shown in FIG. 9, a first connecting terminal (for example, a source) of the power switch MNDC is coupled to a negative terminal of the battery, and a second connecting terminal (for example, a drain) of the power switch MNDC is coupled to the second power port P−. In the specific embodiment shown in FIG. 9, the charging and discharging power switch MNDC is an NMOS transistor.

In order to ensure that the potential of the driving signal SW_GATE is low enough to turn off the charging and discharging power switch MNDC, and to avoid a forward bias conduction leakage of the parasitic diode from the bulk to the source or drain of the NMOS power switch MNDC when the gate voltage of the NMOS power switch MNDC is lower than the threshold voltage, the lower voltage selection circuit 580 is provided. The lower voltage selection circuit 580 has a first input terminal coupled with a first connecting terminal of the charging and discharging power switch MNDC, a second input terminal coupled with a second connecting terminal of the charging and discharging power switch MNDC, and an output terminal coupled with the bulk of the charging and discharging power switch MNDC. The lower voltage selection circuit 580 is configured to selectively couple the bulk of the charging and discharging power switch MNDC to one of the first connecting terminal and the second connecting terminal of the charging and discharging power switch MNDC with the lower voltage. When the battery discharges to the outside, the voltage of the first connecting terminal of the charging and discharging power switch MNDC is lower than the voltage of the second connecting terminal of the charging and discharging power switch MNDC. At this time, the low-voltage selection circuit 580 couples the bulk of the charging and discharging power switch MNDC with the first connecting terminal of the charging and discharging power switch MNDC. When the battery is charged, the voltage of the first connecting terminal of the power switch MNDC is higher than the voltage of the second connecting terminal of the power switch MNDC. At this time, the low-voltage selection circuit 580 couples the bulk of the charging and discharging power switch MNDC with the second connecting terminal of the charging and discharging power switch MNDC. In this way, the charging and discharging protection of the battery can be realized by using just one power switch MNDC.

In the embodiment shown in FIG. 9, the charge pump 510 provides the first voltage CP_OUT, the second power terminal E of the driving circuit is coupled to the first power port P+, and the first power port P+ is coupled to the positive terminal of the battery. The voltage of the first power port P+ may be referred to as the second voltage. The first power port P+ and the second power port P− may be coupled to the load system. The output terminal SW_GATE of the drive circuit is coupled to the control terminal of the power switch MNDC, and the control terminal of the drive circuit receives the control signal output by the battery detection circuit 520. The driving circuit outputs the driving signal SW_GATE to the control terminal of the power switch MNDC through the output terminal thereof according to the received control signal, so as to drive the power switch MNDC to be turned on or off.

In the embodiment shown in FIG. 9, the driving circuit comprises a primary driving unit 530 and a secondary driving unit. The primary driving unit 530 comprises a PMOS transistor MP1, an NMOS transistor MN1 and a unidirectional conduction element. The diode D1 is used as the unidirectional conduction element in FIG. 9. The PMOS transistor MP1 and the diode D1 are coupled in series between the second power terminal E of the driving circuit and the output terminal SW_GATE of the driving circuit. The diode D1 is conductive in a direction from the second power terminal E of the driving circuit to the output terminal SW_GATE of the driving circuit, and the diode D1 is not conductive in a direction from the output terminal SW_GATE of the driving circuit to the second power terminal E of the driving circuit. In the specific embodiment shown in FIG. 9, the PMOS transistor MP1 and the diode D1 are sequentially coupled in series between the second power terminal E of the driving circuit and the output terminal SW_GATE of the driving circuit. The PMOS transistor MP1 has a source coupled to the second power terminal E of the driving circuit, a drain coupled to the positive terminal of the diode D1. The negative terminal of the diode D1 is coupled to the output terminal SW_GATE of the driving circuit. The NMOS transistor MN1 is coupled between the output terminal SW_GATE of the driving circuit and the bulk of the power switch MNDC. The gate of the PMOS transistor MP1 and the gate of the NMOS transistor MN1 are coupled to the control terminal A of the driving circuit. When the control signal is at the first logic level, it indicates that the discharging or charging loop of the battery is abnormal, the PMOS transistor MP1 is controlled to be turned off and the NMOS transistor MN1 is controlled to be turned on. When the control signal is at the second logic level, it indicates that the discharging or the charging loop of the battery is normal, the PMOS transistor MP1 is controlled to be turned on and the NMOS transistor MN1 is controlled to be turned off.

The secondary driving unit has a first connecting terminal coupled to the first power terminal C of the driving circuit, a second connecting terminal coupled to the output terminal SW_GATE of the driving circuit, and a control terminal coupled to the control terminal of the driving circuit. When the control signal is at the first logic level, it indicates that the discharging or charging loop of the battery is abnormal, the secondary driving unit is controlled to cut off the connection between the first power terminal C of the drive circuit and the output terminal SW_GATE of the drive circuit. When the control signal is at the second logic level, it indicates that the discharging or charging loop of the battery is normal, the secondary driving unit is controlled to couple the first power terminal C of the driving circuit to the output terminal SW_GATE of the driving circuit.

In the specific embodiment shown in FIG. 9, the secondary driving unit comprises a level shift module 560 and a PMOS transistor MP3. The PMOS transistor MP3 has a source coupled with the first power terminal C of the driving circuit, and a drain coupled with the output terminal SW_GATE of the driving circuit. The level shift module 560 has an input terminal coupled to the control terminal of the driving circuit, an output terminal coupled to a gate of the PMOS transistor MP3. The level shift module 560 is configured to perform level shift on the received control signal to generate the level shift signal ctrl_CP, and output the level shift signal ctrl_CP to the gate of the PMOS transistor MP3. The high level of the level shift signal ctrl_CP is equal to the first voltage CP_OUT provided by the charge pump 510. When the control signal is at the first logic level, the PMOS transistor MP3 is controlled to be turned off by the level shift module 560, so that the connection between the first power terminal C of the driving circuit and the output terminal SW_GATE of the driving circuit is cut off. When the control signal is at the second logic level, the level shift module 560 controls the PMOS transistor MP3 to be turned on, so that the secondary driving unit couples the first power terminal C of the driving circuit with the output terminal SW_GATE of the driving circuit.

In order to facilitate the understanding of the present invention, a working process of the battery protection circuit shown in FIG. 9 for driving the charging and discharging power switch MNDC will be described in detail below. When the control signal is at the high level which may be referred to as the first logic level, it indicates that the discharging and charging loop of the BATTERY CELL is abnormal. At this time, the level shift signal ctrl_CP output by the level shift module 560 is at the high level which is equal to the first voltage CP_OUT, the PMOS transistor MP3 is controlled to be turned off; the PMOS transistor MP1 is controlled to be turned off, the NMOS transistor MN1 is controlled to be turned on. The output terminal of the driving circuit is pulled down to the voltage of the bulk of the charging and discharging power switch MNDC by the NMOS transistor MN1, so that the discharging and charging power switch is turned off, and the discharging and charging loop of the battery is turned off.

When the control signal is at the low level which may be referred to as the second logic level, it indicates that the discharging and charging loop of the battery is normal. At this time, the level shift signal ctrl_CP output by the level shift module 560 is at the low level, the PMOS transistor MP3 is controlled to be turned on, the PMOS transistor MP1 is controlled to be turned on, the NMOS transistor MN1 to be turned off. The output terminal of the driving circuit is pulled up to the larger one between the first voltage CP_OUT and the second voltage by the PMOS transistor MP3 and the PMOS transistor MP1, so that the charging and discharging power switch MNDC is driven to be turned on, and the discharging and charging loop of the battery is turned on.

The unidirectional conduction element allows the PMOS transistor MP1 to pull up the voltage of the output terminal SW_GATE of the driving circuit when the voltage of the source of the PMOS transistor MP1 is higher than the voltage of the output terminal SW_GATE of the driving circuit. However, when the output terminal of the driving circuit is pulled up to a voltage higher than the voltage of the source of the PMOS transistor MP1 by the PMOS transistor MP3, the unidirectional conduction element prevents the output terminal of the driving circuit from flowing current back to the second power terminal E through the PMOS transistor MP1.

In the embodiment shown in FIG. 9, the first voltage CP_OUT provided by the charge pump 510 is higher than the second voltage provided by the first power port P+. The voltage of the first power port P+ is equal to the voltage of the positive terminal of the battery, so that when the PMOS transistor MP3 is turned on, the output terminal SW_GATE of the driving circuit can be pulled up to the first voltage CP_OUT higher than the voltage of the positive terminal of the battery to drive the charging and discharging power switch MNDC to be turned on, thereby reducing the limitation of the voltage of the battery to the high potential of the driving signal SW_GATE.

Referring now to FIG. 10, it shows a schematic circuit diagram of the battery protection circuit according to a sixth embodiment of the present invention. The battery protection circuits shown in FIG. 10 and FIG. 9 are basically the same, and the main difference between the battery protection circuits shown in FIG. 10 and FIG. 9 is that the source of the PMOS transistor MP1 is not coupled to the first power port P+ in FIG. 10, but is coupled to the output voltage LDO_OUT of the linear voltage regulator 570. It can also be said that the second power terminal E of the driving circuit is not coupled to the first power port P+ in FIG. 10, but is coupled to the output voltage LDO_OUT of the linear voltage regulator 570. The first voltage CP_OUT provided by the charge pump 510 is higher than the output voltage LDO_OUT of the linear voltage regulator 570 which may be referred to as the second voltage. The working processes of the battery protection circuits shown in FIG. 10 and FIG. 9 are basically the same and will not be repeated here.

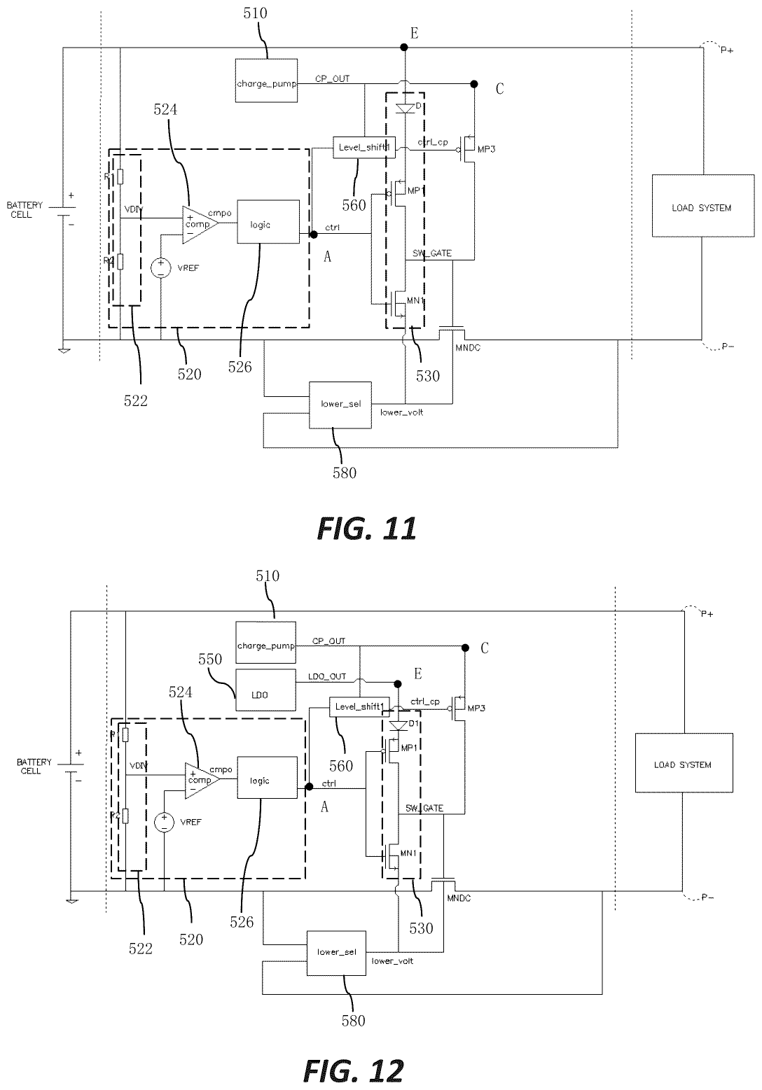

FIG. 11 is a schematic diagram of the battery protection circuit according to a seventh embodiment of the present invention. The battery protection circuits shown in FIG. 11 and FIG. 9 are basically the same, and the main differences between the battery protection circuits shown in FIG. 11 and FIG. 9 are as follows: the diode D1 and the PMOS transistor MP1 are sequentially coupled in series between the second power terminal E of the driving circuit and the output terminal SW_GATE of the driving circuit. Specifically, the positive terminal of the diode D1 is coupled to the second power terminal E of the driving circuit, the negative terminal of the diode D1 is coupled with the source of the PMOS transistor MP1, and the drain of the PMOS transistor MP1 is coupled with the output terminal SW_GATE of the driving circuit.

FIG. 12 shows a schematic circuit diagram of the battery protection circuit according to an eighth embodiment of the present invention. The battery protection circuits shown in FIG. 12 and FIG. 10 are basically the same, and the main differences between the battery protection circuits shown in FIG. 12 and FIG. 10 are as follows: the diode D1 and the PMOS transistor MP1 are sequentially coupled in series between the second power terminal E of the driving circuit and the output terminal SW_GATE of the driving circuit. Specifically, the positive terminal of the diode D1 is coupled with the second power terminal E, the negative terminal of the diode D1 is coupled with the source of the PMOS transistor MP1, and the drain of the PMOS transistor MP1 is coupled with the output terminal SW_GATE of the driving circuit.

To sum up, the battery protection circuit provided by the present invention comprises a battery detection circuit 520, at least one power switch and at least one driving circuit. The battery detection circuit 520 is configured for detecting a charging and discharging state of a battery and generating at least one control signal. Each power switch comprises a control terminal and coupled in series in a charging and discharging loop of the battery. Each driving circuit corresponds to one of the at least one power switch and one of the at least one control signal, comprises a first power terminal coupled to a first voltage, a second power terminal coupled to a second voltage, an output terminal coupled to the control terminal of corresponding one of the at least one power switch and a control terminal receiving corresponding one of the at least one control signal, and outputs a driving signal to the control terminal of the corresponding one of the at least one power switch based on the corresponding one of the at least one control signal received by the control terminal thereof so as to turn on or off the corresponding one of the at least one power switch. Each driving circuit selects a higher voltage from the first voltage and the second voltage as a voltage of the driving signal to turn on the corresponding one of the at least one power switch. The at least one control signal may be the charge control signal chg_ctrl, the discharge control signal dischg_ctrl, and the control signal ctrl. The at least one power switch may be the discharging power switch MND, the charging power switch MNC, and the charging and discharging power switch MNDC. The second voltage may be the voltage of the first power port P+ and the output voltage LDO_OUT of the linear voltage regulator 570. In this way, the charge pump 510 can increase the high potential of the drive signal for the gate of the power transistor MND, MNC, or MNDC to be higher than the positive potential of the battery, so that the limitation of the voltage of the battery to the high potential of the driving signal is reduced, the conduction capability of the power transistor is fully and stably exerted, and the purposes of reducing the on-resistance of the power transistor, improving the charging and discharging efficiency of the battery and reducing the heating are achieved. In one embodiment, the battery protection circuit provided by the present invention further comprises the charge pump 510, which provides the first voltage CP_OUT.

In the embodiments shown in FIG. 5 to FIG. 8, the battery detection circuit 520 generates two control signals, comprises two driving circuits and two power switches. The two control signals are respectively referred to as the charging control signal chg_ctrl and the discharging control signal dischg_ctrl. The two driving circuits are respectively referred to as the first driving circuit and the second driving circuit. The first driving circuit corresponds to the discharge control signal dischg_ctrl and the discharging power switch MND. The second driving circuit corresponds to the charging power switch MNC and the charge control signal chg_ctrl. The discharging power switch MND and the charging power switch MNC are sequentially coupled in series between the negative terminal of the battery and the second power port P−. The source of the discharging power switch MND is coupled with the negative terminal of the battery, and the drain of the discharging power switch is coupled with that of the charging power switch MNC. The source of the charging power switch MNC is coupled with the second power port P−, the source of the discharging power switch MND is coupled with the bulk of the discharging power switch MND, and the source and the bulk of the charging power switch MNC are coupled.

In the embodiments shown in FIG. 9-12, the battery detection circuit 520 generates one control signal, and comprises one driving circuit and one power switch. The first connecting terminal of the charging and discharging power switch MNDC is coupled with the negative terminal of the battery, and the second connecting terminal of the charging and discharging power switch MNDC is coupled with the second power port P−. The battery protection circuit further comprises a lower voltage selection circuit 580, a first input terminal of the lower voltage selection circuit 580 is coupled with the first connecting terminal of the charging and discharging power switch MNDC, a second input terminal thereof is coupled with the second connecting terminal of the charging and discharging power switch MNDC. The output terminal is coupled with the bulk of the charging and discharging power switch MNDC, and the lower voltage selection circuit 580 is used for selectively coupling the bulk of the charging and discharging power switch MNDC to one terminal with lower voltage between the first connecting terminal and the second connecting terminal of the discharging and charging power switch MNAC.

Although preferred embodiments of the present invention have been described, additional changes and modifications to these embodiments may be made once the basic creative concepts are known to those skilled in the art. The appended claims are therefore intended to be interpreted to comprise preferred embodiments and all changes and modifications falling within the scope of this application.

Obviously, a person skilled in the art may make various changes and variations to the application without departing from the spirit and scope of the application. Thus, if these modifications and variations of this application fall within the scope of the claims and their equivalent technologies, the application is also intended to comprise these changes and variations.

What is claimed is:

1. A battery protection circuit, comprising:
a battery detection circuit configured for detecting a charging or discharging state of a battery and generating at least one control signal;
a power switch, including a control terminal and coupled in series in a charging and discharging loop of the battery; and
a driving circuit, corresponding to the power switch and the control signal, including a first power terminal coupled to a first voltage, a second power terminal coupled to a second voltage, an output terminal coupled to the control terminal of the power switch and a control terminal receiving the control signal, and outputting a driving signal to the control terminal of the power switch based on the control signal so as to turn on or off the power switch, wherein the driving circuit selects a higher voltage from the first voltage and the second voltage as a voltage of the driving signal to turn on the power switch.

2. The battery protection circuit according to claim 1, wherein the driving circuit comprises:
a primary driving unit comprising a first PMOS transistor, an NMOS transistor and a unidirectional conduction element, wherein the first PMOS transistor and the unidirectional conduction element are coupled in series between the second power terminal of the driving circuit and the output terminal of the driving circuit, the unidirectional conduction element is conductive in a direction from the second power terminal of the driving circuit to the output terminal of the driving circuit and is not conductive in a direction from the output terminal of the driving circuit to the second power terminal of the driving circuit, the NMOS transistor is coupled between the output terminal of the driving circuit and a bulk of the corresponding one of the at least power switch, and a gate of the first PMOS transistor and a gate of the NMOS transistor are coupled to the control terminal of the driving circuit;
a secondary driving unit comprising a first connecting terminal coupled to the first power terminal of the driving circuit, a second connecting terminal coupled to the output terminal of the driving circuit, and a control terminal coupled to the control terminal of the driving circuit, wherein when the control signal received by the driving circuit is a first logic level, the first PMOS transistor is turned off and the NMOS transistor is turned on, the secondary driving unit is controlled to decouple the first power terminal of the driving circuit from the output terminal of the driving circuit, when the control signal received by the driving circuit is a second logic level, the first PMOS transistor is turned on and the NMOS transistor is turned off, the secondary driving unit is controlled to couple the first power terminal of the driving circuit to the output terminal of the driving circuit.

3. The battery protection circuit according to claim 2, wherein the secondary driving unit comprises a level shift module and a second PMOS transistor,
the second PMOS transistor comprises a source coupled to the first power terminal of the driving circuit, a drain coupled to the output terminal of the driving circuit, and a gate;
the level shift module has an input terminal coupled to the control terminal of the driving circuit, and an output terminal coupled to the gate of the second PMOS transistor, the level shift module is configured to perform level shift on the received control signal to generate a level shift signal, and output the level shift signal to the gate of the second PMOS transistor, wherein a high level of the level shift signal is equal to the first voltage.

4. The battery protection circuit according to claim 1, further comprising:
a charge pump providing the first voltage which is greater than the second voltage, wherein the at least one power switch is coupled in series between a negative terminal of the battery and a second power port P−, and a positive terminal of the battery is coupled to a first power port P+,
each power switch is a NMOS transistor, the control terminal of the power switch is a gate of the NMOS transistor, a first connecting terminal and a second connecting terminal of the power switch are a source and a drain of the NMOS transistor.

5. The battery protection circuit according to claim 1, wherein the second voltage is a voltage of a first power port P+ coupled to a positive terminal of the battery; or the battery protection circuit further comprises a linear voltage regulator configured to provide the second voltage.

6. The battery protection circuit according to claim 1, wherein the at least one control signal comprises one control signal, the at least one power switch comprises one power switch, and the at least one driving circuit comprises one driving circuit,
the power switch comprises a first connecting terminal coupled to a negative terminal of the battery and a second connecting terminal coupled to a second power port P−,
the battery protection circuit further comprises a lower voltage selection circuit comprising a first input terminal coupled to the first connecting terminal of the power switch, a second input terminal coupled to the second connecting terminal of the power switch, and an output terminal coupled to a bulk of the power switch, the lower voltage selection circuit is configured for selectively connecting the bulk of the power switch to one of the first connecting terminal and the second connecting terminal of the power switch with lower voltage.

7. The battery protection circuit according to claim 6, wherein the driving circuit comprises:
a primary driving unit comprising a first PMOS transistor, an NMOS transistor and a unidirectional conduction element, wherein the first PMOS transistor and the unidirectional conduction element are coupled in series between the second power terminal of the driving circuit and the output terminal of the driving circuit, the unidirectional conduction element is conductive in a direction from the second power terminal of the driving circuit to the output terminal of the driving circuit and is not conductive in a direction from the output terminal of the driving circuit to the second power terminal of the driving circuit, the NMOS transistor is coupled between the output terminal of the driving circuit and the bulk of the power switch, and a gate of the first PMOS transistor and a gate of the NMOS transistor are coupled to the control terminal of the driving circuit;
a secondary driving unit comprising a first connecting terminal coupled to the first power terminal of the driving circuit, a second connecting terminal coupled to the output terminal of the driving circuit, and a control terminal coupled to the control terminal of the driving circuit, wherein when the control signal received by the driving circuit is a first logic level, the first PMOS transistor is turned off and the NMOS transistor is turned on, the secondary driving unit is controlled to discouple the first power terminal of the driving circuit from the output terminal of the driving circuit, when the control signal received by the driving circuit is a second logic level, the first PMOS transistor is turned on and the NMOS transistor is turned off, the secondary driving unit is controlled to couple the first power terminal of the driving circuit to the output terminal of the driving circuit.

8. The battery protection circuit according to claim 7, wherein the secondary driving unit comprises a level shift module and a second PMOS transistor,
the second PMOS transistor comprises a source coupled to the first power terminal of the driving circuit, a drain coupled to the output terminal of the driving circuit, and a gate;
the level shift module has an input terminal coupled to the control terminal of the driving circuit, and an output terminal coupled to the gate of the second PMOS transistor, the level shift module is configured to perform level shift on the received control signal to generate a level shift signal, and output the level shift signal to the gate of the second PMOS transistor, wherein a high level of the level shift signal is equal to the first voltage.

9. The battery protection circuit according to claim 6, further comprising:
a charge pump providing the first voltage which is greater than the second voltage,
wherein the power switch is coupled in series between a negative terminal of the battery and a second power port P−, and a positive terminal of the battery is coupled to a first power port P+,
the second voltage is a voltage of a first power port P+ coupled to a positive terminal of the battery; or the battery protection circuit further comprises a linear voltage regulator configured to provide the second voltage,
the power switch is a NMOS transistor, the control terminal of the power switch is a gate of the NMOS transistor, a first connecting terminal and a second connecting terminal of the power switch are a source and a drain of the NMOS transistor.

10. The battery protection circuit according to claim 1, wherein the at least one control signal comprises two control signals which are respectively referred to as a charging control signal and a discharging control signal, the at least one driving circuit comprises two driving circuits which are respectively referred to as a first driving circuit and a second driving circuit, the at least one power switch comprises two power switches which are respectively referred to as a charging power switch and a discharging power switch,
the first driving circuit corresponds to the discharging control signal and the discharging power switch, the second driving circuit corresponds to the charging control signal and the charging power switch;
the discharging power switch comprises a source coupled to a negative terminal of the battery and a bulk thereof, a drain coupled to a drain of the charging power switch, and a gate used as the control terminal thereof,
the charging power switch comprises a source coupled to a second power port P− and a bulk thereof, a drain coupled to the drain of the discharging power switch, and a gate used as the control terminal thereof.

11. The battery protection circuit according to claim 10, wherein each driving circuit comprises:
a primary driving unit comprising a first PMOS transistor, an NMOS transistor and a unidirectional conduction element, wherein the first PMOS transistor and the unidirectional conduction element are coupled in series between the second power terminal of the driving circuit and the output terminal of the driving circuit, the unidirectional conduction element is conductive in a direction from the second power terminal of the driving circuit to the output terminal of the driving circuit and is not conductive in a direction from the output terminal of the driving circuit to the second power terminal of the driving circuit, the NMOS transistor is coupled between the output terminal of the driving circuit and the bulk of the power switch, and a gate of the first PMOS transistor and a gate of the NMOS transistor are coupled to the control terminal of the driving circuit;
a secondary driving unit, comprising a first connecting terminal coupled to the first power terminal of the driving circuit, a second connecting terminal coupled to the output terminal of the driving circuit and a control terminal coupled to the control terminal of the driving circuit, wherein when the control signal received by the driving circuit is a first logic level, the first PMOS transistor is turned off and the NMOS transistor is turned on, the secondary driving unit is controlled to discouple the first power terminal of the driving circuit from the output terminal of the driving circuit, when the control signal received by the driving circuit is a second logic level, the first PMOS transistor is turned on and the NMOS transistor is turned off, the secondary driving unit is controlled to couple the first power terminal of the driving circuit to the output terminal of the driving circuit.

12. The battery protection circuit according to claim 11, wherein the secondary driving unit comprises a level shift module and a second PMOS transistor,
the second PMOS transistor comprises a source coupled to the first power terminal of the driving circuit, a drain coupled to the output terminal of the driving circuit, and a gate;
the level shift module has an input terminal coupled to the control terminal of the driving circuit, and an output terminal coupled to the gate of the second PMOS transistor, the level shift module is configured to perform level shift on the received control signal to generate a level shift signal, and output the level shift signal to the gate of the second PMOS transistor, wherein a high level of the level shift signal is equal to the first voltage.

13. The battery protection circuit according to claim 10, wherein further comprising:
a charge pump providing the first voltage which is greater than the second voltage,
wherein the first power switch and the second power switch are coupled in series between a negative terminal of the battery and a second power port P−, and a positive terminal of the battery is coupled to a first power port P+,
the second voltage is a voltage of a first power port P+ coupled to a positive terminal of the battery; or the battery protection circuit further comprises a linear voltage regulator configured to provide the second voltage,
each power switch is a NMOS transistor.

14. The battery protection circuit according to claim 13, wherein the unidirectional conduction element and the first PMOS transistor are sequentially coupled in series between the second power terminal of the driving circuit and the output terminal of the driving circuit, the unidirectional conduction element in the first driving circuit and the unidirectional conduction element in the second driving circuit are the same unidirectional conduction element.
